(19) United States
(12) Patent Application Publication
(10) Pub. No.: US 2006/0050156 A1
(43) Pub. Date: Mar. 9, 2006

(54) Information processing device

(75) Inventor: Masao Onuki, Tokyo (JP)

Correspondence Address: OLIFF & BERRIDGE, PLC, P.O. BOX 19928, ALEXANDRIA, VA, 22320, US

(73) Assignee: NIKON CORPORATION, TOKYO (JP)

(21) Appl. No.: 11/267,283

(22) Filed: Nov. 7, 2005

Related U.S. Application Data
(63) Continuation of application No. 09/965,095, filed on Sep. 28, 2001, now abandoned.
Application No. 09/965,095 is a continuation of application No. 08/900,446, filed on Jul. 25, 1997, now abandoned.

(30) Foreign Application Priority Data
Aug. 13, 1996 (JP) 8-213493

(51) Int. Cl. H04N 5/225

(52) U.S. Cl. 348/231.99; 348/207.99

(57) ABSTRACT

An image processing device such as an electronic camera prevents external devices from writing to a first storage region of a memory, while allowing the external device to write to a second storage region of the memory. Accordingly, even when the external device operates irregularly, information stored in the first storage region cannot be erased or corrupted. According to a second aspect, two connectors provided on the electronic camera so that the camera can be attached to different external devices are arranged on the outer housing of the camera so that when the first connector is connected to an external device, the second connector is covered. Conversely, when the second connector is connected to an external device, the first connector is covered. This prevents both connectors from being simultaneously connected to two different external devices, and lessens the possibility of causing an excessive voltage within the camera.

This is a Continuation of application Ser. No. 09/965,095 filed Sep. 28, 2001, which in turn is a Continuation of application Ser. No. 08/900,446 filed Jul. 25, 1997. The entire disclosure of each of the prior applications is hereby incorporated by reference herein in its entirety.

### INCORPORATION BY REFERENCE

The disclosure of the following priority application is herein incorporated by reference: Japanese Patent Application No. 8-213493 filed Aug. 13, 1996.

### BACKGROUND OF THE INVENTION

1. Field of the Invention

The present invention relates to an information processing device, and relates in particular to an information processing device such as, for example, an electronic camera having a memory that is divided into plural regions and that can be linked to an external device such as, for example, a personal computer.

2. Description of Related Art

In conjunction with the progress that has been made in information processing technology, electronic cameras have been developed that photograph objects utilizing a photo-electric conversion element such as, e.g., a CCD (Charge Coupled Device) and the like. Some of these electronic cameras are provided with a serial interface, such as an RS232C interface, for example, that can be connected to a serial port of a personal computer (PC) through a prescribed cable.

When the electronic camera is connected to a PC through this type of interface, photographed image data can be transmitted to the personal computer from the electronic camera.

However, a problem can arise when a PC that is operating irregularly is connected to the electronic camera. For example, an unexpected (and undesirable) operation may be performed by the PC relative to the electronic camera that causes the electronic camera to not function properly. For example, the PC may change (or erase) operating parameters for the electronic camera, which are stored in the electronic camera's memory.

Another problem that can exist with the electronic cameras arises due to the fact that they are provided with multiple connection terminals that can be connected to multiple external devices and that receive electric power from these external devices. In particular, if electric power is simultaneously supplied from multiple external devices (through the different connectors), then an abnormal (excessive) electrical current is generated within the electronic camera. This can damage the internal circuitry of the electronic camera.

Even when the multiple external devices are supposed to supply electric power at the same fixed voltage, e.g., 5 volts, variations in the voltage of the electric power source of each external device, even to the extent of +/−0.1 volts, raises the possibility that differences will occur in the supplied electrical voltage.

### SUMMARY OF THE INVENTION

According to one aspect of the invention, an information processing device such as, for example, an electronic camera prevents external devices from accessing a first storage region of a memory, while allowing the external device to access a second storage region of the memory. Accordingly, even when the external device operates irregularly, information stored in the first storage region cannot be erased or corrupted.

In particular, an information processing device incorporating this aspect of the invention includes a controller coupled to a connector and to a memory, the controller preventing external devices connected to the connector from accessing a first storage region of the memory. The memory includes a first storage region and a second storage region. The connector enables the information processing device to be connected to an external device (such as, for example, a personal computer) that is separate from the information processing device.

When the information processing device is an electronic camera, it includes a lens and a photoelectric converter upon which the lens focuses an image of the object so that the photoelectric converter generates electronic image data. The lens and the photoelectric converter can be located in a housing of the electronic camera and the controller can be coupled to the photoelectric converter to control the storage of the electronic image data in the memory. Specifically, the controller can store the electronic image data generated by the photoelectric converter in the second region of the memory. The controller can enable external devices connected to the connector to access the second region of the memory.

According to a second aspect of the invention, two connectors that are provided on an image processing device such as, for example, an electronic camera, so that the camera can be attached to different external devices are arranged on the outer housing of the camera so that when the first connector is connected to an external device, the second connector is covered. Conversely, when the second connector is connected to an external device, the first connector is covered. This prevents both connectors from being simultaneously connected to two different external devices. Therefore, the possibility of causing an excessive voltage within the camera is lessened.

An information processing device incorporating this aspect of the invention includes a first connector by which the information processing device is connectable to a first external device that supplies power to the information processing device through the first connector and a second connector by which the information processing device is connectable to a second external device that supplies power to the information processing device through the second connector. The first connector and the second connector are arranged relative to each other on a surface of the information processing device such that when the first connector is connected to the first external device, the second connector is prevented from being connected to the second external device, and when the second connector is connected to the second external device, the first connector is prevented from being connected to the first external device.

The information processing device can also include a lens and a photoelectric converter upon which the lens focuses an image of an object to be photographed so that the photoelectric converter generates electronic image data. A processor located in the information processing device processes the electronic image data.

### BRIEF DESCRIPTION OF THE DRAWINGS

The invention will be described in conjunction with the following drawings in which like reference numerals designate like elements and wherein:

FIG. 1 is a perspective external view of an electronic camera, which is one type of information processing device according to an embodiment of the present invention;

FIG. 2 is a perspective view of the FIG. 1 electronic camera connected to a personal computer;

FIG. 3 is a perspective view of the internal construction of the FIG. 1 electronic camera;

FIG. 4 is a block diagram of one example of the components of the FIG. 1 electronic camera; and

FIG. 5 illustrates the storage regions of the flash memory of FIG. 4.

### DETAILED DESCRIPTION OF PREFERRED EMBODIMENTS

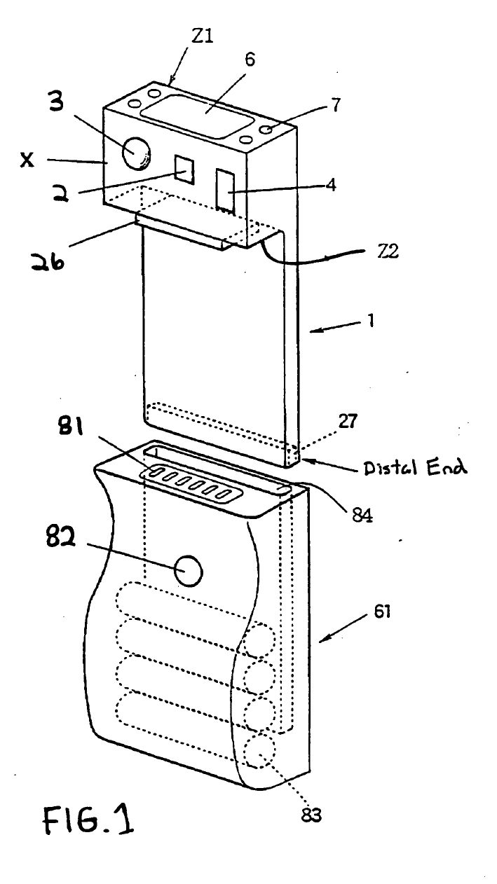

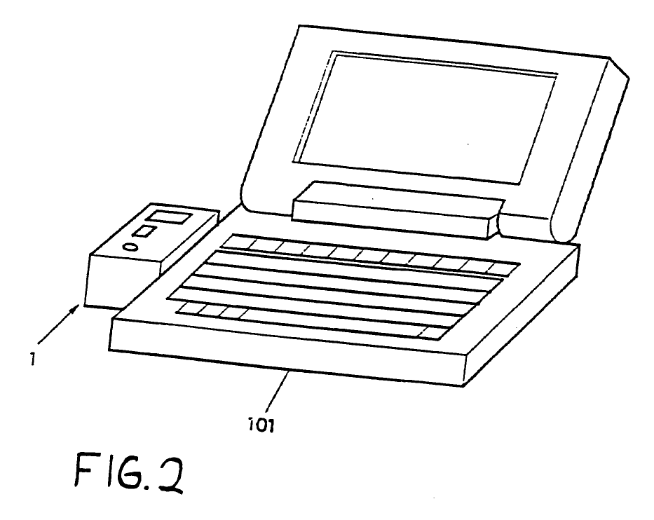

Embodiments of the present invention are described hereafter with reference to the drawings. Referring to FIG. 1, an electronic camera 1 performs photography of a photographic object when it is connected to a holder 61 (a first external device). The holder 61 includes a release button 82, which is operated at the time of photography, and a power source comprised of a plurality of batteries 83, which provides electric power to each electronic circuit. As shown in FIG. 2, electronic camera 1 also can be connected to a designated expansion slot of a personal computer 101 (a second external device). When connected to the PC 101, the camera 1 receives a signal based on operations performed by the personal computer 101, and then accomplishes processing corresponding to the signal.

A surface X of the electronic camera 1, which faces the photographic object at the time of photography, includes a viewfinder 2, a photographic lens 3 and a strobe 4. The viewfinder 2 presents the photographic scope of the photographic object to the user. The photographic lens 3 obtains the optical image of the photographic object. The strobe 4 flashes a light to illuminate the photographic object.

An LCD 6 and operation keys 7 are provided on an upper surface Z1 of the electronic camera 1. LCD 6 displays the photographed image. Operation keys 7 are operated by the user to perform a number of functions.

A first connector 26 is arranged on the surface Z2, which is the lower surface of the electronic camera 1. When the distal end of the electronic camera 1 is inserted into an opening 84 of the holder 61, i.e., when the holder 61 is mounted to the electronic camera 1, connector 26 is electrically connected to a first connector 81 of the holder 61. Signals corresponding to the electric power of the battery 83 and to the operation of the release button 82 (i.e., control signals and a power signal) are supplied to the electronic camera 1 from the holder 61 through the first connector 26 and the first connector 81.

A second connector 27 is arranged on the distal end of the electronic camera 1. Second connector 27 includes, for example, a connection terminal of the standard PCMCIA (Personal Computer Memory Card International Association) type, and is designed so as to be connectable to the connection terminal (i.e. the bus) of the personal computer 101 via an expansion slot of the personal computer. Electric power for the internal electronic circuitry of the electronic camera 1 (which requires one of multiple types of voltage (for example 5 volts and 12 volts)) and a signal corresponding to a specified process (i.e., a control signal) are supplied to the electronic camera 1 from the personal computer 101 through second connector 27.

As is known, the personal computer 101 can be connected to an alternating current source. By means of an internally housed AC/DC converter (not shown), the personal computer 101 converts the alternating electric power from the alternating current source to direct current electric power, and supplies the direct current electric power to the electronic camera 1 via connector 27.

When the electronic camera 1 is connected to the holder 61 (via first connectors 26 and 81), the second connector 27 is located within the opening 84 of the holder 61. In such a condition, the second connector 27 is not electrically connected to anything, not even to the holder 61. Thus, due to the arrangement of connectors 26 and 27 on the housing of the camera 1, when connector 26 is connected (to connector 81), connector 27 is prevented from being electrically connected to other external devices (i.e., it is electrically isolated).

When the electronic camera 1 is connected to the personal computer 101 (via second connector 27 and the PC expansion slot), the first connector 26 makes contact with the side surface of the personal computer 101. In such a condition, the first connector 26 is not electrically connected to anything, not even to the personal computer 101. Thus, due to the arrangement (i.e., the relative locations) of connectors 26 and 27 on the housing of the electronic camera 1, when connector 27 is connected (to the PC bus via the PC expansion slot), connector 26 is prevented from being electrically connected to other external devices (i.e., it is electrically isolated).

In this manner, since only the first connector 26 or the second connector 27 can be connected to the holder 61 or to the personal computer 101, respectively, there is no simultaneous supply of electric power from the holder 61 and the personal computer 101.

It is possible to implement this aspect of the invention by alternative means. For example, the connectors 26 and 27 could include covers that are selectively locked in a closed position. In such an example, when one of the connectors is attached to an external device, the cover of the other connector is locked. The connectors 26 and 27 could also be selectively disabled so that when one connector is connected to an external device, the other connector is disabled.

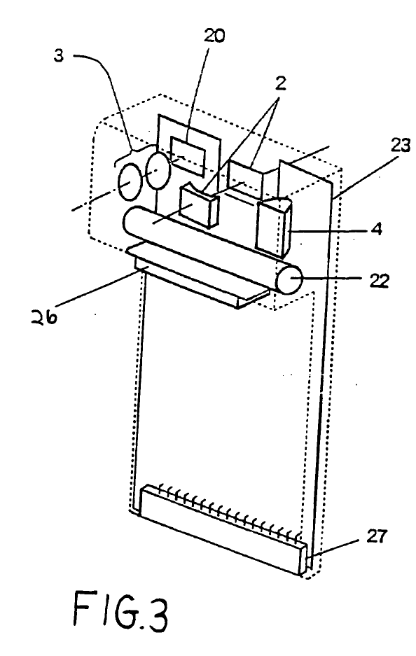

Next, referring to FIG. 3, one possible construction of the internal parts of the electronic camera 1 is described. A CCD 20 is provided behind the photographic lens 3 so that the light image of the photographic object focused by the photographic lens 3 is photo-electrically converted into an electric signal. Photoelectric conversion devices other than a CCD can be used with the invention.

Located vertically below the viewfinder 2, the photographic lens 3 and the strobe 4 is a condenser (or capacitor) 22. Condenser 22 accumulates electric charge for outputting a flash of the light by the strobe 4.

Various control circuits for controlling each part of the electronic camera 1 are formed on a circuit board 23. A flash memory 24 (explained hereafter) is provided on the circuit board 23. The data of the photographed picture image and various parameters are stored in the flash memory 24.

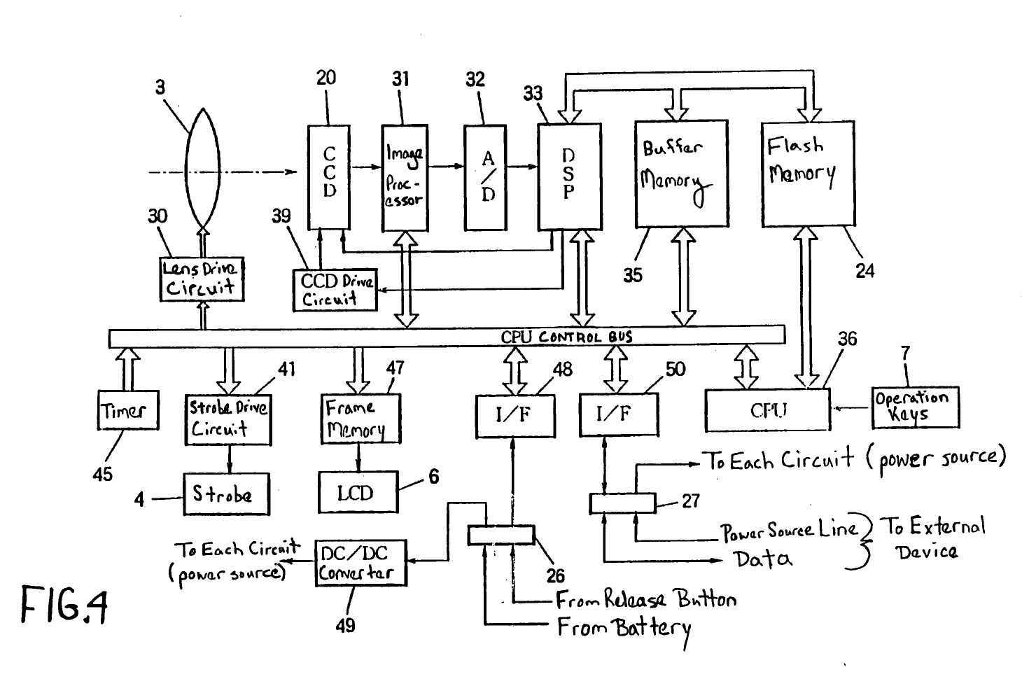

Next, one possible electrical construction of the components of the electronic camera 1 of the present embodiment is explained with reference to the block diagram shown in FIG. 4. The CCD 20, which includes a plurality of pixels, photo-electrically converts the light images focused onto each pixel into image signals. A digital signal processor (referred to hereafter as DSP) 33 supplies a CCD horizontal drive pulse to the CCD 20. DSP 33 also controls the CCD drive circuit 39 and supplies a CCD vertical drive pulse to the CCD 20.

An image processor 31 is controlled by a CPU 36, and samples in a prescribed timing the image signals photo-electrically converted by the CCD 20. An analog-to-digital converter (referred to hereafter as the A/D converter) 32 digitizes the image signals sampled by the image processor 31, and supplies the digitized signals to the DSP 33.

The DSP 33 controls the data bus connected to the buffer memory 35 and the flash memory 24. In particular, after the image data supplied from the A/D converter 32 is temporarily stored in the buffer memory 35, the image data stored in the buffer memory 35 is read out and then recorded in the flash memory 24.

The DSP 33 also can store the picture image data supplied from the A/D converter 32 in the frame memory 47, whereupon the image data is displayed on the LCD 6. The image data stored in flash memory 24 is read out by the DSP 33, and the image data is then stored into frame memory 47, to be displayed on LCD 6.

The buffer memory 35 is used to harmonize any differences between the input/output speed of the data relative to the flash memory 24, and the processing speed of the CPU 36 and the DSP 33.

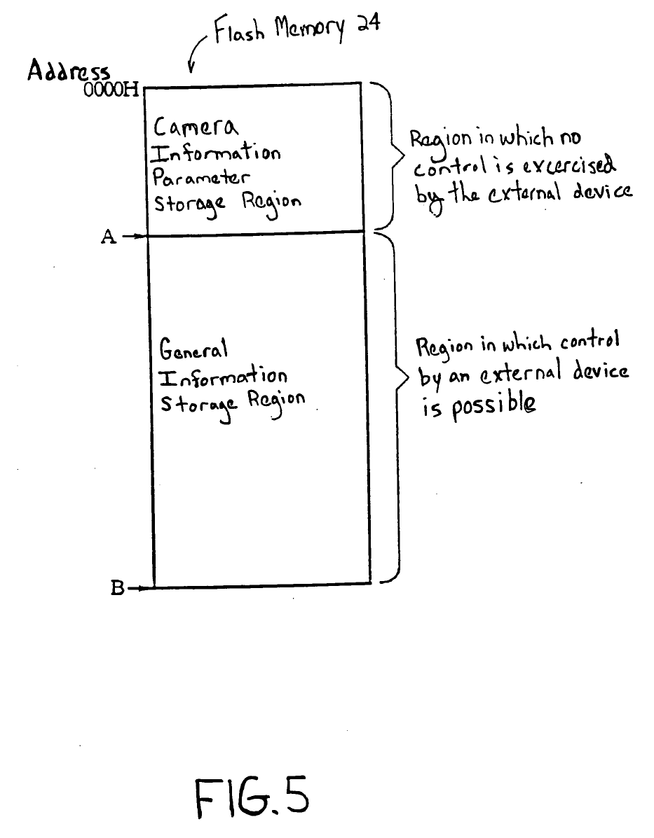

The flash memory 24 includes non-volatile memory elements. FIG. 5 shows an example of the manner in which data is allocated to the storage regions of the flash memory 24. In the first region (address 0000H-address A) of the flash memory 24 is stored the parameter data essential to the control of the electronic camera 1. In the second region (address A-address B) is stored image data of the photographed image and data that is handled by the personal computer 101.

Data that can be stored in the first region of the flash memory 24 includes, for example, the date and time data (8 bit data which identifies the year, month, day, hour, minute, and second), which is generated by the timer 45, data corresponding to the quantization table used to perform compression processing by the JPEG (Joint Photography Experts Group) format, and data relating to the operation of the strobe 4 (automatic flash, flash prevention, forced flash, and the presence or lack thereof of a red eye reduction lamp). Additional data that can be stored in the first region includes, for example, the total number of frames of photographed picture images (number of frames of picture images recorded in the second region of the flash memory 24) data relating to the electronic camera 1 such as the serial number of the electronic camera 1, and the manufacturing lot number, and data such as the correction data of the output level of each color value (RGB) of the CCD 20.

It would also be appropriate to store the diaphragm value in the case when the established value of the shutter speed is provided, as well as when the diaphragm mechanism is situated between the photographic lens 3 and the CCD 20, along with correction data used at the time of establishing these values, in the first region of the flash memory 24.

The CPU 36 is programmed or set-up so as to write any signals supplied from the personal computer 101 through the second connector 27 and the interface I/F 50 only to the second region of the flash memory 24. In other words, the CPU 36 does not write any signals supplied from the personal computer 101 to the first region.

The CPU 36 also can be programmed or set-up so as to output the picture image data recorded in the second region of the flash memory 24 to the personal computer 101, through the I/F 50 and through the second connector 27.

By controlling the CPU 36 in this manner, even when the personal computer 101 is operating irregularly, the signal supplied from the personal computer 101 is only read into the second region of flash memory 24. Accordingly, there is no erasure or overwriting of the parameters essential to the operation of the electronic camera 1, which are recorded in the first region of the flash memory 24.

In addition to controlling the strobe drive circuit 41, which causes the appropriate amount of light to be flashed by the strobe 4, CPU 36 also controls the lens drive circuit 30 to perform an autofocus operation by moving the photographic lens 3.

The CPU 36 also retrieves signals from the operations keys 7, which can include, for example, a power source switch, and processes these signals in an appropriate manner.

The timer 45 internally houses a back-up battery, and outputs data corresponding to the current time to the CPU 36.

When the electronic camera 1 is connected to the holder 61, an interface (I/F) 48 outputs signals from the release button 82, which are supplied through the first connector 26 from the holder 61 to the CPU 36.

When the electronic camera 1 is connected to the holder 61, a DC/DC converter 49 converts the voltage supplied from the batteries 83 connected through the first connector 26 to the appropriate operating voltage for each circuit provided in the electronic camera 1, and supplies that voltage to each circuit.

When the electronic camera 1 is connected to the personal computer 101, the I/F 50 outputs signals supplied from the personal computer 101 through the second connector 27 to the CPU 36. Additionally, when the electronic camera 1 is connected to the personal computer 101, the second connector 27 supplies electric power from the personal computer 101 to each circuit.

Next, an explanation is provided with respect to various operations of the electronic camera 1 according to the present embodiment. First, an explanation is provided with regard to the photography operation of the electronic camera 1.

Initially, after the distal end of the electronic camera 1 is inserted into the opening 84 of the holder 61 to connect the electronic camera 1 to the holder 61, the power source switch, which is one of the operation keys 7, is operated to supply power to the electronic camera 1. In other words, the camera is turned ON. The photographic object is confirmed by means of the view-finder 2, and when the release button 82 of the holder 61 is depressed, the photographic processing of the image commences.

The light image of the photographic object observed through the viewfinder 2 is focused by means of the photographic lens 3 onto the CCD 20, which includes a plurality of pixels. The light image of the photographic object formed on the CCD 20 is photo-electrically converted to image signals by each pixel, and sampling is accomplished by the image processor 31. The image signals sampled by the image processor 31 are supplied to the A/D converter 32, and are then output to the DSP 33 in digitized form.

The DSP 33, after outputting the image data to the buffer memory 35 where it is temporarily stored, reads out the image data from the buffer memory 35, and stores the image data in the flash memory 24. At this time, the DSP 33 preferably compresses the image data in accordance with the JPEG format, which combines discrete cosine transformation, quantization and Huffman encoding. Thus, compressed image signals are stored in the flash memory 24. Other compression techniques could be used.

When the release button 82 is continuously depressed, the DSP 33 outputs the image data obtained during that time to the frame memory 47, and the photographed image is displayed on the LCD 6.

In addition, as necessary, the strobe 4 is operated, permitting illumination of the photographic object.

When the electronic camera is connected to the personal computer 101, it is also possible to perform photography by operating the personal computer 101.

Next, an explanation is provided with regard to the operation of the electronic camera 1 in the case when access to the flash memory 24 is accomplished by the personal computer 101.

Initially, as shown in FIG. 2, the distal end (including the second connector 27) of the electronic camera 1 is inserted into the expansion slot of the personal computer 101 so that the personal computer 101 is electrically connected to the electronic camera 1. When a designated operation in the personal computer 101 is performed by the user, a signal (i.e., commands) is output to the electronic camera 1 via the bus within the personal computer 101 and the expansion slot.

The electronic camera 1 retrieves the signal via the I/F 50 and the second connector 27. The I/F 50 also outputs this signal to the CPU 36. When the signal includes a write command, the CPU 36 determines whether the address that is the subject of the write command is within the second region of the flash memory 24. If the address is determined to be an address within the second region, then the data included in the command is written to the address by the CPU 36.

Conversely, when the CPU 36 determines that the address is within the first region (and not within the second region), then the write command is not executed by the CPU 36.

When the supplied command is a read command, then the CPU 36 determines whether the read-out address is within the second region. If the address is determined to be an address within the second region, then the address is accessed, and the data at that address is read-out by the CPU 36 and output to the personal computer 101 through the I/F 50 and the second connector 27.

Conversely, if the CPU 36 determines that the address is within the first region (not within the second region) then the read command is not executed by the CPU 36.

In this manner, the CPU 36 determines whether or not the address which is the subject of the command received from the personal computer 101 is within the second region. When it is determined that the address is in other than the second region (in other words in the first region) then access by the personal computer 101 relative to the first region is prevented.

In the above embodiment, by inserting the end of the electronic camera 1 into the personal computer 101, both units are connected. However, the connection methodology is not restricted to this single embodiment.

While this invention has been described in conjunction with specific embodiments thereof, it is evident that many alternatives modifications and variations will be apparent to those skilled in the art. Accordingly, the preferred embodiments of the invention set forth herein are intended to be illustrative, not limiting. Various changes may be made without departing from the spirit and scope of the invention as defined in the following claims.

What is claimed is:

1. An information processing device comprising:
storage means for storing data, said storage means having a first region and a second region, both of which are capable of storing data;
connection means for enabling the information processing device to be connected to an external device that is separate from the information processing device; and
prevention means for preventing external devices connected to the connection means from accessing the first region of the storage means.

2. The device of claim 1, further comprising:
photography means, located in the information processing device, for photographing an object and generating electronic image data of the object; and
processing means, located in the information processing device, for processing the electronic image data.

3. The device of claim 2, wherein the electronic image data generated by the photography means is stored in the second region of the storage means, and the prevention means enables external devices connected to the connection means to access the second region of the storage means.

4. The device of claim 2, wherein the photography means includes a lens and a photoelectric converter upon which the lens focuses an image of the object so that the photoelectric converter generates the electronic image data, such that the information processing device is an electronic camera.

5. The device of claim 1, wherein the prevention means enables external devices connected to the connection means to access the second region of the storage means.

6. An information processing device comprising:
a memory having a first storage region and a second storage region;
a connector by which the information processing device can be connected to an external device that is separate from the information processing device; and
a controller coupled to the connector and to the memory, the controller preventing external devices connected to the connector from accessing the first storage region of the memory.

7. The device of claim 6, wherein the device is an electronic camera, the device further comprising:
a lens and a photoelectric converter upon which the lens focuses an image of the object so that the photoelectric converter generates electronic image data, the lens and the photoelectric converter located in a housing of the electronic camera; wherein:
the controller is coupled to the photoelectric converter and controls the storage of the electronic image data in the memory.

8. The device of claim 7, wherein the controller stores the electronic image data generated by the photoelectric converter in the second region of the memory, and the controller enables external devices connected to the connector to access the second region of the memory.

9. The device of claim 6, wherein the controller enables external devices connected to the connection means to access the second region of the memory.

10. A method of controlling an information processing device having a memory that is partitioned into a first storage region and a second storage region, and a connector by which the information processing device can be connected to an external device that is separate from the information processing device; the method comprising the steps of:
determining whether a request to access the first storage region of the memory is initiated by an external device connected to the connector; and
denying access to the first storage region of the memory if the request was initiated by the external device.

11. The method of claim 10, wherein the device is an electronic camera having a lens and a photoelectric converter upon which the lens focuses an image of the object so that the photoelectric converter generates electronic image data, the lens and the photoelectric converter located in a housing of the electronic camera; wherein the electronic image data is stored in the memory.

12. The method of claim 11, wherein the electronic image data generated by the photoelectric converter is stored in the second region of the memory, and further comprising the step of enabling external devices connected to the connector to access the second region of the memory when an external device connected to the connector requests access to the second storage region of the memory.

13. The method of claim 10, further comprising the step of enabling external devices connected to the connector to access the second region of the memory when an external device connected to the connector requests access to the second storage region of the memory.

14. The method of claim 10, wherein the request to access is a request to write data to the first storage region of the memory.

15. The method of claim 10, wherein the request to access is a request to read data from the first storage region of the memory.

16. An information processing device comprising:
photography means, located in the information processing device, for photographing an object and generating electronic image data of the object;
processing means, located in the information processing device, for processing the electronic image data;
first connection means for connecting the information processing device to a first external device that supplies power to the information processing device through the first connection means;
second connection means for connecting the information processing device to a second external device that supplies power to the information processing device through the second connection means; wherein:
when the first connection means is connected to the first external device, the second connection means is prevented from being connected to the second external device, and when the second connection means is connected to the second external device, the first connection means is prevented from being connected to the first external device.

17. The device of claim 16, further comprising conversion means for converting the power supplied through the first connection means to a predetermined voltage level and for converting the power supplied through the second connection means to the predetermined voltage level.

18. The device of claim 16, wherein the first external device internally houses a battery that supplied a direct current to the first connection means.

19. The device of claim 16, wherein the second external device obtains its power from an alternating current source, converts the alternating current to a direct current and supplies the direct current to the second connection means.

20. An information processing device comprising:
photography means, located in the information processing device, for photographing an object and generating electronic image data of the object;
processing means, located in the information processing device, for processing the electronic image data;
first connection means for connecting the information processing device to a first external device that supplies power to the information processing device through the first connection means;
second connection means for connecting the information processing device to a second external device that supplies power to the information processing device through the second connection means; wherein:
means for preventing the second connection means from being connected to the second external device when the first connection means is connected to the first external device, and for preventing the first connection means from being connected to the first external device when the second connection means is connected to the second external device.

21. An information processing device comprising:
a lens and a photoelectric converter upon which the lens focuses an image of an object to be photographed so that the photoelectric converter generates electronic image data;
a processor located in the information processing device to process the electronic image data;
a first connector by which the information processing device is connectable to a first external device that supplies power to the information processing device through the first connector;
a second connector by which the information processing device is connectable to a second external device that supplies power to the information processing device through the second connector; wherein:
the first connector and the second connector are arranged relative to each other on a surface of the information processing device such that when the first connector is connected to the first external device, the second connector is prevented from being connected to the second external device, and when the second connector is connected to the second external device, the first connector is prevented from being connected to the first external device.
